(19) United States
(12) Patent Application Publication
(10) Pub. No.: US 2004/0091136 A1
(43) Pub. Date: May 13, 2004

(54) Real-time biometric data extraction and comparison for self identification

(76) Inventor: James Douglas Dombrowski, Santa Ana, CA (US)

Correspondence Address: Kit M. Stetina, STETINA BRUNDA GARRED & BRUCKER, 75 Enterprise, Suite 250, Aliso Viejo, CA, 92656, US

(21) Appl. No.: 10/293,647

(22) Filed: Nov. 13, 2002

(51) Int. Cl. G06K 9/00

(52) U.S. Cl. 382/115

(57) ABSTRACT

A system and method for authenticating an identification device (such as an identification card or a credit card) comprising stored biometric identification information and a person using the identification device are disclosed. Biometric data is read from stored biometric identification information on the identification device. A representation of biometric data of the person using the identification device is obtained. The representation of the biometric data obtained from the person using the identification device is formatted into a format that can be used to generate a template. The template is generated from the formatted data. The generated template is compared to a template included in the stored biometric identification information stored on the identification device to determine if the person using the identification device is the identification device owner. If the generated template matches the template on the identification device, authentication data stored on the identification device is validated to determine if the identification device is valid identification device.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to personal identity security methods and more particularly to a system and method for performing real-time (immediate) validation of an identification card or a security card based on human biometrics.

Identity theft and privacy are issues of increasing concern to consumers as well as businesses. Substantial numbers of transactions using credit cards occur every day. These transactions include Internet or e-commerce purchases as well as purchases at brick and mortar stores.

Fraud prevention by eliminating losses from stolen or misappropriated credit cards will benefit businesses, financial institutions, and individuals.

Physical access controls, e.g., entry into a building or a room, may include biometric authorization. For example, a scanner may scan the iris of an individual and compare it to iris data stored in a database in order to determine if the individual is authorized to enter the facility. This type of authorization is secure yet non-invasive.

There is no comparable protection for a person's identity. For example, credit cards include a place for the owner's signature that may be visually compared by a store clerk. However, this is not infallible. Furthermore, there is no way of knowing whether the person who signed the card is the true owner of the card. Smart cards can be used to store data and contain logic for performing various functions. (No known smart cards, to date, have been used to store biometric data in order to provide security for the card owner and prevent fraud and identity theft.)

Therefore, there is a clear need for a non-invasive method for preventing fraud and identity theft of credit cards while at the same time protecting the privacy of the credit card owner.

### BRIEF SUMMARY OF THE INVENTION

A system and method for validating or authenticating an identification device comprising stored biometric identification information and a person using the identification device are disclosed. The validation or authentication process reads the stored biometric data from the identification device and in conjunction with a biometric data acquisition device, obtains a representation of the biometric data of the person using the identification device. The biometric data acquisition representation of the biometric data obtained from the individual using the biometric data acquisition device is formatted into a format that can be used to generate at least one template and then at least one template is generated. The generated template is compared to at least one template on the identification device to determine if the person using the identification device provided the biometric data in the template stored on the identification device. If the generated template data matches the template data on the identification device, the encrypted authentication data stored on the identification device is validated to verify that the identification device was created using a predefined creation process.

The biometric data may comprise but is not limited to iris data, retina data, face data, lip movement data, hand/finger geometry data, keystroke data, fingerprint data, nail data, signature, vein data, DNA or voice data.

The identification device may be any device capable of storing biometric template information such as: a credit card, identification card, or CD-card (Compact Disc).

The biometric identification information may be stored on the identification device. For example, credit card or identification card (using a high-density magnetic strip, a high-density magnetic patch, or PDF417 barcode (high-density two dimensional symbology)), or optical CD-card.

### BRIEF DESCRIPTION OF THE DRAWINGS

These as well as other features of the present invention will become more apparent upon reference to the drawings wherein:

FIG. 1A is a block diagram illustrating exemplary logic of data acquisition for an enrollment process;

FIG. 1B is a block diagram illustrating exemplary logic for completing the enrollment process of FIG. 1A;

FIG. 2 is a block diagram illustrating exemplary logic for performing identity verification using a biometric template stored on a card that has been enrolled using the enrollment process shown in FIGS. 1A and 1B;

FIG. 3 illustrates identification information, including biometric information that is added to an identification device, such as an identification card, a credit card, or an optical CD-Card;

FIGS. 4A-4D illustrate various examples of placement of biometric information on an identification card, credit card, or optical CD-Card;

FIG. 5 illustrates an exemplary embodiment of a commercial credit card reader for reading and authenticating a credit card or identification card having biometric information stored thereon; and

FIG. 6 illustrates an exemplary embodiment of a personal credit card reader for reading and authenticating a credit card or identification card having human biometric information stored thereon.

### DETAILED DESCRIPTION OF THE INVENTION

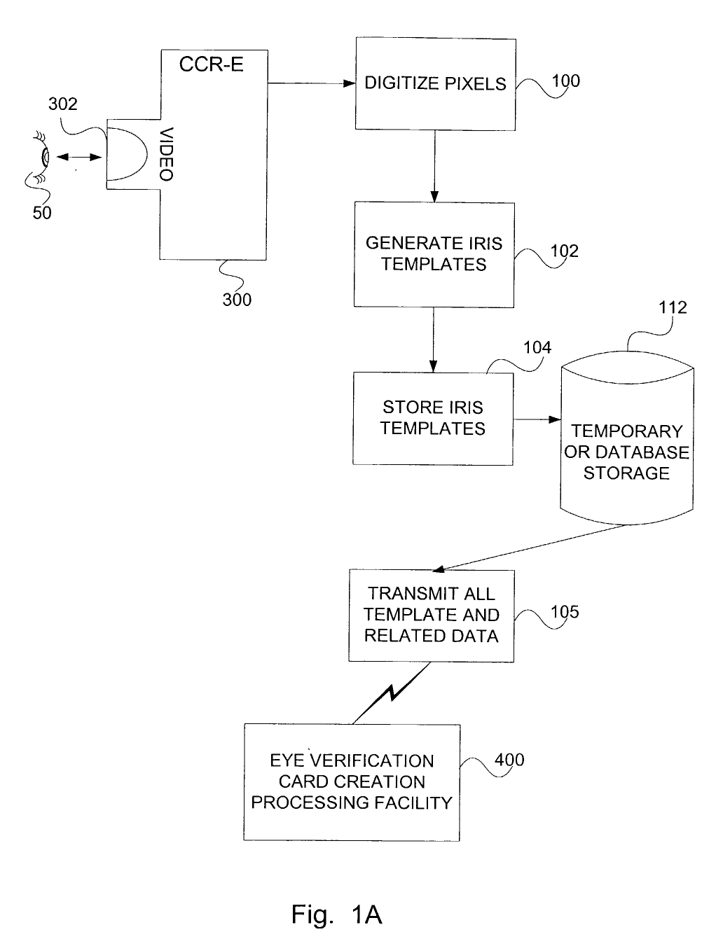

Referring now to the Figures wherein the drawings are for purposes of illustrating preferred embodiments of the present invention only, and not for purposes of limiting the same, FIG. 1A-1B are block diagrams illustrating exemplary logic for performing an enrollment process for a card authorization using biometrics. The example illustrates capturing iris biometric data and storing the biometric template temporarily in a database 112. The templates and all other related data are subsequently transmitted to an Eye Verification Card Creation Processing Facility 400. The Eye Verification Card Creation Processing Facility 400 encrypts the biometric templates and writes the encrypted data on a magnetic stripe area or PDF417 high-density barcode area of a new or re-issued credit card. A CD-Card can be equally well employed. The new or re-issued card is then mailed to the consumer.

A credit card enrollment processor 300 obtains video data of human biometric information. The credit card enrollment processor 300 includes a video camera 302 for obtaining biometric information that can be recorded by the credit card enrollment processor 300. The camera component 302 can be any camera that can generate video formats. In the example shown and described herein, a picture of the eye 50, and more particularly a picture of the iris, is taken by the camera 302 in order to obtain iris information. It will be appreciated that other human biometrics can be used. For example, face, face/lip movement, hand/finger geometry, retina, keystroke pattern/pace/pressure, nail, signature, vein, voice, fingerprint, DNA, etc.

After the video information is obtained, the data is formatted, for example by digitizing the pixels. See block 100. The formatting converts the data into a format that is expected by the template generating process. One or more templates are generated from the formatted, (e.g., digitized) image. See block 102. The templates can be created using existing technology. For example, Iridian® Technologies, Inc. of Moorestown N.J. and Geneva, Switzerland develops and markets technologies for extracting biometric data from the iris. In the iris example, at least two templates are generated, one for the left iris and one for the right iris.

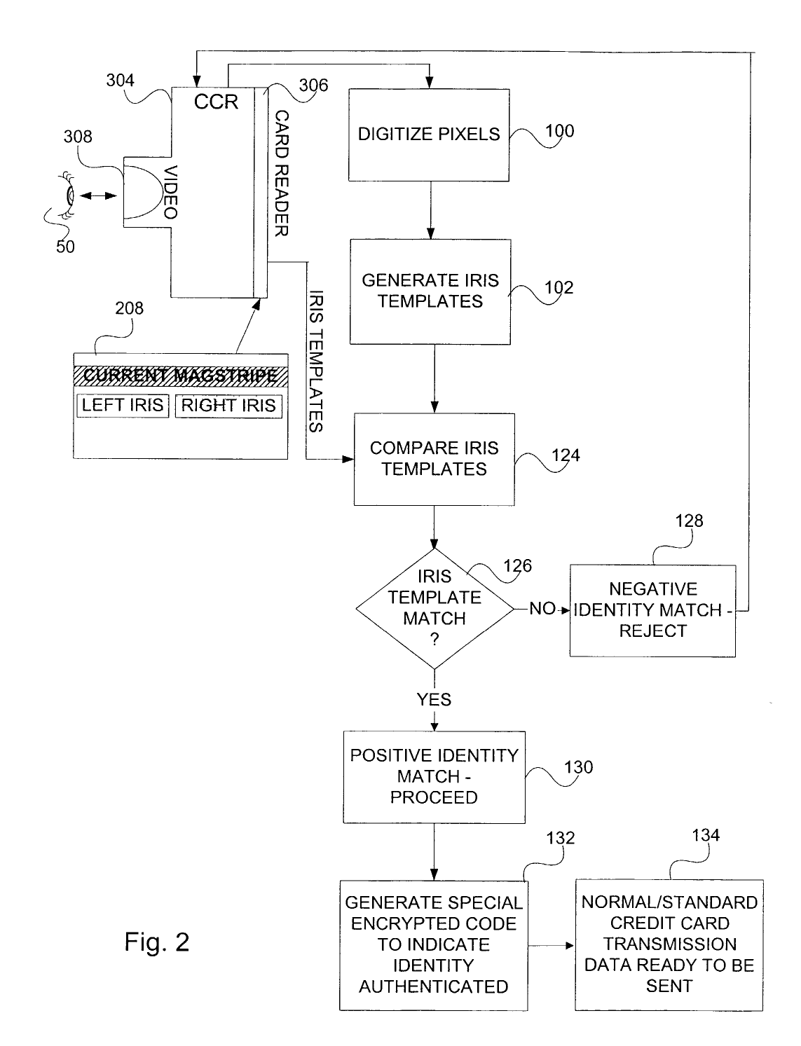

The template information is stored. See block 104. The information may be stored in a database or in temporary storage 112. Encrypted validation/verification information and the template information are stored on the identification device. For example, as shown in FIG. 3, the identification information 200 to be stored on the card includes encrypted prefix data 204 and/or encrypted suffix data 206 that is pre-pended and/or appended, respectively, to the biometric template data 202. This encrypted prefix 204 or suffix data 206 provides validation information that the person identified by the biometric data stored in the template has been enrolled using the enrollment process of FIGS. 1a-1b.

The identification device may be a credit card and/or a debit card with a high-density magnetic strip, PDF417 high-density barcode strip or optical CD-card (compact disc). The identification device may also be an identification card, such as a driver's license or a social security card. The magnetic identification information 200 which includes encrypted validation information 204, 206 and human biometric information 202 may be stored using the high-density strip, high-density patch, PDF417 high-density barcode strip, or CD-card. Exemplary high-density strips, patches, or CD-cards can store as much as, but not limited to 640 bytes of data per eye.

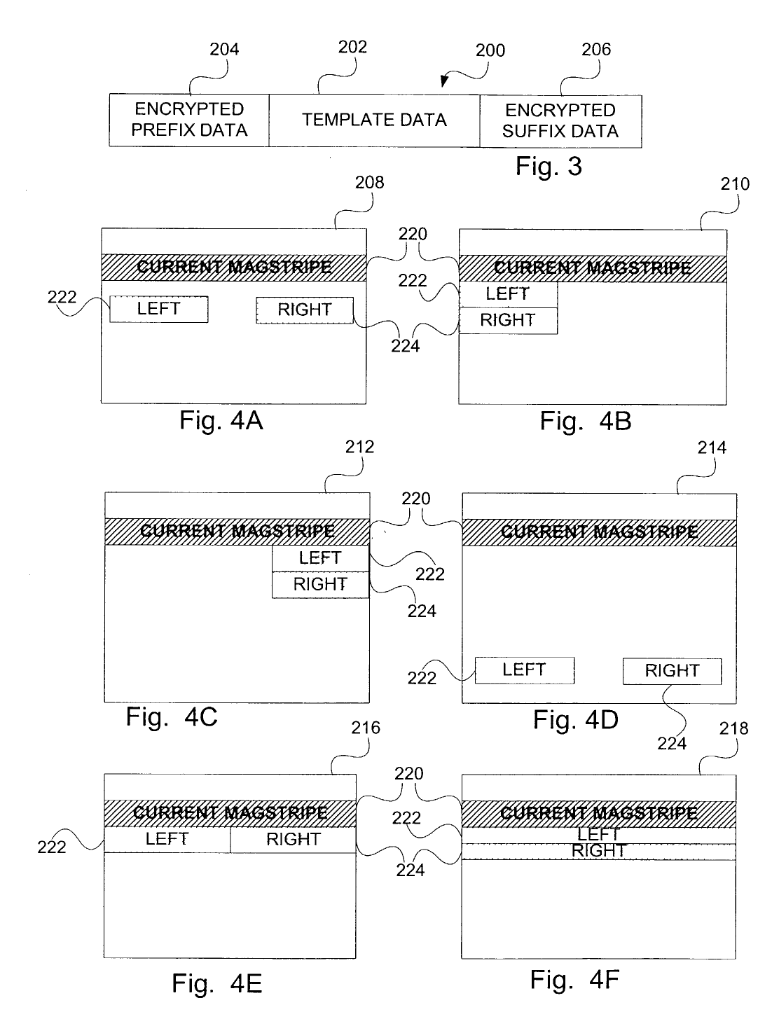

FIGS. 4A-4F illustrate several examples of possible placement of the high-density data storage strip or patch. The exemplary cards shown 208, 210, 212, 214, 216, and 218 each include the current magnetic stripe (magstripe) 220. Each of the cards 208, 210, 212, 214, 216, 218 also includes one or more high-density strips or patches. In the illustrated example, there are two high-density strips or patches per card 208, 210, 212, 214, 216, 218. Each of these strips or patches 200 includes template data 202 and encrypted identification information 204, 206 as shown in FIG. 3. The template information in one of the strips or patches is template information for the left iris 222 and the template information in the other strip or patch is template information for the right iris 224. As can be seen in FIGS. 4A-4F, the patches or strips can be placed at various locations on the card 208, 210, 212, 214, 216, 218. A level of security can be supplied by locating sections of storage at various positions on the card or storage device making it necessary to know the sequence of the locations in order to ‘decrypt’ the information. In exemplary embodiments, the current magstripe 220 is not modified. However, in other embodiments, the magstripe 220 but could be modified if the entire stripe were converted to high-density technology which could store the template information of both the left iris 222 and the right iris 224.

Referring to FIG. 1A, the template information and other identification information is stored in a temporary location 112. The consumer participation in the enrollment process is complete when identification has been certified and their iris templates have been successfully stored 104 for offline processing. Preferably, this information is transmitted 105 to an offsite location 400 for final offline batch processing.

The offsite location 400 (for security purposes) will perform the final steps of creating the identification device 208. These steps include encrypting iris codes on the identification device 106 and writing the identification information 200 (shown in FIG. 3) on the identification device 208 using a card writer 108. The enrollment process is then completed by sending the identification device (e.g., card) 208 to the card owner 110. In the case of a credit card, the consumer participation portion of the enrollment process (FIG. 1A) is performed at the bank or other transaction location (e.g., financial institution) providing the credit or debit card. In the case of an identification card, the enrollment process can be performed at the appropriate institution, e.g., Department of Motor vehicles, bank, Social Security office, or “Identity Verification Agency.”

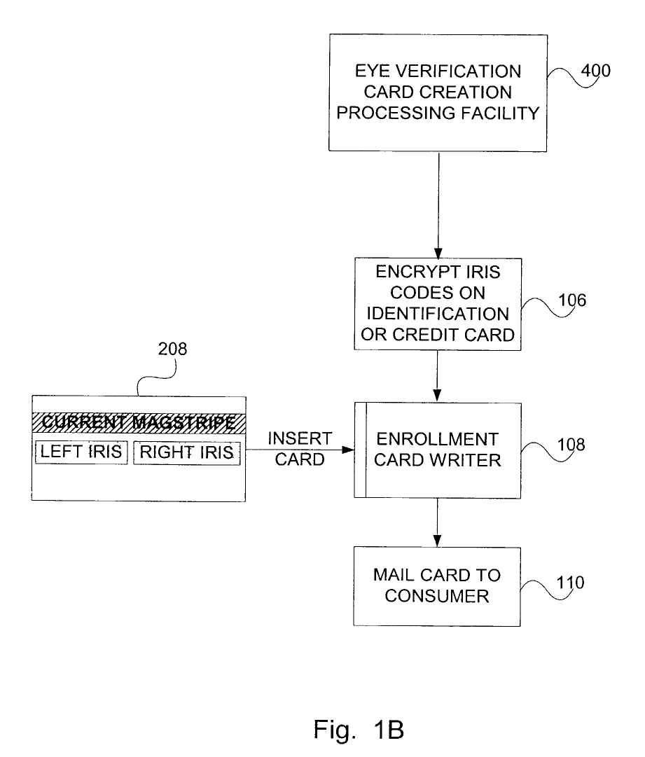

When the consumer uses the card, an authentication/validation/verification process such as the one shown in FIG. 2 is performed. The card 208 is read by a card reader 306 which is a part of or in communication with a credit card reader processor 304. The credit card reader processor 304 also includes a video camera 308 for obtaining biometric information from the person using the card. Since the biometric information used in the enrollment process shown in FIG. 1A is iris information, iris information is used to validate that the user is the owner of the card. After the iris data is obtained, the pixels are digitized. See block 100. Iris templates are then generated. See block 102. The processes up to this point (obtaining biometric information, digitizing it (block 100) and generating templates (block 102)) parallels the initial steps of the enrollment process (shown in FIG. 1A). The template(s) generated in step 102 is then compared to the appropriate template(s) read from the card 208 by the card reader 306.

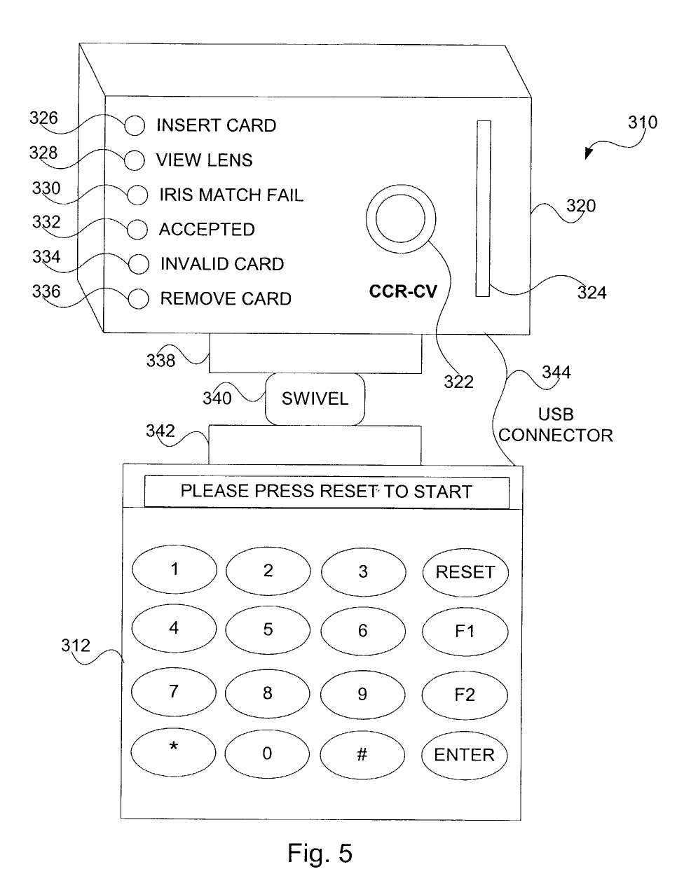

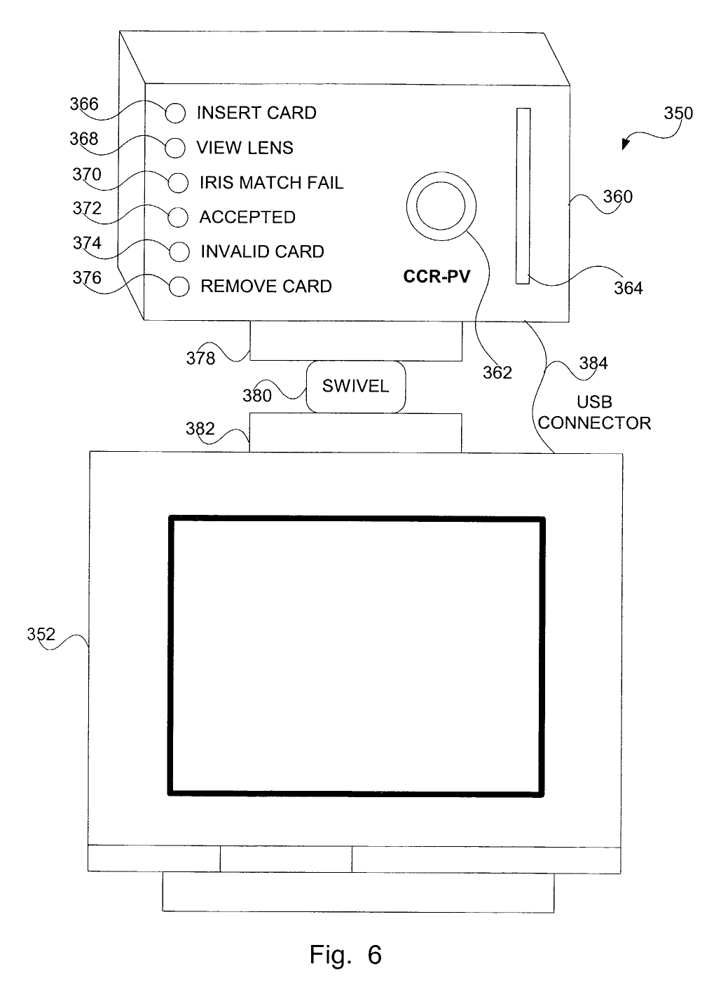

If the template(s) do not match (no in decision block 126), there is a negative identity match and the card is rejected. Appropriate rejection processing is then performed. As described in further detail later, the credit card reader may be a commercial version (FIG. 5) or a personal version (FIG. 6). In the commercial context, the person performing the validation (e.g., a store clerk or bank teller) may confiscate the card and may notify authorities of the invalid cardholder. In the case of the personal version, all card data and mis-matched templates will be transmitted to a secure location for investigation of potential fraud.

If the template(s) do match (yes in decision block 126), there is a positive identity match (block 130). A special encrypted code is generated to indicate that the identity has been authenticated. This will be a special code that indicates that the transaction has successfully passed the “Eye Verification” security check. The special encrypted code contains all of the necessary information to be passed on to the credit card processor. This encryption is performed to prevent the merchant of being a victim of internal fraud. The merchant will never see the actual credit card account number. See block 132. Normal or standard processing is then performed. For example, if the card is a credit card, the credit transaction continues.

FIG. 5 illustrates an exemplary commercial embodiment 310. The commercial credit card reader 320 is attached to an existing system 312. An example of an existing system is a payment system, such as payment systems developed and sold by Verifone®, Inc. of Santa Clara, Calif. In the embodiment shown, a connector 342 is attached to the existing system 312 and a connector 338 is attached to the credit card reader 320. The two connectors 338, 342 are attached via a swivel connector 340. In the embodiment shown, the credit card reader 320 and the existing system 312 communicate data and online information over Universal Serial Bus (USB). The credit card reader 320 includes an input device, such as a camera 322 for obtaining the real-time biometric information and a card reader 324 for reading the card that includes templates having biometric data of the card owner. The credit card reader 320 includes logic such as that shown in FIG. 2 for verifying the user by comparing the biometric information obtained from the user (via camera 322) with the biometric information stored on the card read by card reader 324.

The credit card reader 320 also includes indicators to assist the user in performing the validation process. In the embodiment shown, there is an Insert Card indicator 326 that is illuminated when the processor 320 is ready to accept a card. Once the card has been accepted, a logic chip in the credit card reader 302 detects the presence of a card. Once the card has been inserted and detected, a View Lens indicator 328 is illuminated. The user then places his eye in front of the lens 322. Validation/Authentication processing is then performed. If the biometric information does not match, an Iris Match Fail indicator 330 is illuminated. If the templates match, an Accepted indicator 332 is illuminated. If there is an error in the encrypted data, an Invalid Card indicator 334 is illuminated. Such an error indicates that the card was not enrolled using the enrollment process of FIG. 1, e.g., the card is a counterfeit card. After processing has been completed, a Remove Card indicator 336 is illuminated and the user can remove the card. The Insert Card 326 indicator is then illuminated to indicate that processing for another user can now be performed. In exemplary embodiments, the different indicators are different colors. For example, the Insert Card indicator 326 is white, the View Lens indicator 328 is yellow, the Iris Match Fail indicator 330 is red, the Accepted Indicator 332 is green, the Invalid Card indicator 334 is red and the Remove Card indicator 336 is blue.

FIG. 6 illustrates an exemplary personal embodiment 350. This embodiment communicates with the user's computer and allows for secure online purchasing. The personal credit card reader 360 is essentially the same as the commercial version 310 shown in FIG. 5 and described above. The personal credit card reader 360 communicates with the user's computer via USB 384 and may be attached to the user's monitor 352 as shown in FIG. 6.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A method for authenticating a person using an identification device and the identification device being used, the identification device comprising stored biometric identification information about an owner of the identification device, the stored biometric identification information including encrypted authentication data and at least one template having biometric data representative of the owner of the identification device, the method comprising:
(a) reading the stored biometric identification information from the identification device;
(b) extracting the at least one template from the stored biometric identification information;
(c) obtaining a representation of biometric data of the person using the identification device;
(d) formatting the representation of the biometric data obtained from the person using the identification device into a format that can be used to generate at least one template;
(e) generating at least one template from the formatted data;
(f) comparing the generated template to the at least one template extracted from the stored biometric identification information stored on the identification device to determine if the person using the identification device is the identification device owner; and
(g) if the generated template data matches the template data on the identification device, validating the encrypted authentication data stored on the identification device to determine if the template stored on the identification device was generated using a predefined method.

2. The method of claim 1, wherein the biometric data comprises iris data.

3. The method of claim 1, wherein the biometric data comprises retina data.

4. The method of claim 1, wherein the biometric data comprises face data.

5. The method of claim 1, wherein the biometric data comprises lip movement data.

6. The method of claim 1, wherein the biometric data comprises hand/finger geometry data.

7. The method of claim 1, wherein the biometric data comprises keystroke data.

8. The method of claim 1, wherein the biometric data comprises fingerprint data.

9. The method of claim 1, wherein the biometric data comprises nail data.

10. The method of claim 1, wherein the biometric data comprises signature data.

11. The method of claim 1, wherein the biometric data comprises vein data.

12. The method of claim 1, wherein the biometric data comprises voice data.

13. The method of claim 1, wherein the biometric data comprises DNA data.

14. The method of claim 1, wherein the identification device is a credit card.

15. The method of claim 1, wherein the identification device is an identification card.

16. The method of claim 1, wherein the stored biometric identification information is stored on a magnetic, optical, PDF417 two dimensional symbology, or semi-conductor identification device using available data recording areas on the identification device.

17. A system for authenticating a person using an identification device and the identification device being used, the identification device comprising stored biometric identification information about an owner of the identification device, the stored biometric identification information including encrypted authentication data and at least one template having biometric data representative of the owner of the identification device, the system comprising:
(a) a biometric data acquisition device for obtaining biometric data of the person using the identification device;
(b) a converter for converting the biometric data into an identification device user template;
(c) a reader for reading the stored biometric identification information from the identification device;
(d) a parser for parsing the stored biometric identification information into an identification device owner template comprising biometric data of an identification device owner and encrypted authentication data;
(e) a comparer for comparing the identification device user template to the identification device owner template to determine if the person using the identification device is the identification device owner; and
(f) a validator for validating the encrypted authentication data to determine if the identification device is a valid identification device.

18. The system of claim 17, wherein the biometric data comprises iris data.

19. The system of claim 17, wherein the biometric data comprises retina data.

20. The system of claim 17, wherein the biometric data comprises face data.

21. The system of claim 17, wherein the biometric data comprises lip movement data.

22. The system of claim 17, wherein the biometric data comprises hand/finger geometry data.

23. The system of claim 17, wherein the biometric data comprises keystroke data.

24. The system of claim 17, wherein the biometric data comprises fingerprint data.

25. The system of claim 17, wherein the biometric data comprises nail data.

26. The system of claim 17, wherein the biometric data comprises signature data.

27. The system of claim 17, wherein the biometric data comprises vein data.

28. The system of claim 17, wherein the biometric data comprises voice data.

29. The system of claim 17, wherein the biometric data comprises DNA data.

30. The system of claim 17, wherein the identification device is a credit card.

31. The system of claim 17, wherein the identification device is an identification card.

32. The system of claim 17, wherein the stored biometric identification information is stored on a magnetic, optical, PDF417 two dimensional symbology, or semi-conductor identification device using available data recording areas on the identification device.
